(19) United States
(12) Patent Application Publication
(10) Pub. No.: US 2009/0079896 A1
(43) Pub. Date: Mar. 26, 2009

(54) OPTICAL ELEMENT COVERING MEMBER, BACKLIGHT, LIQUID CRYSTAL DISPLAY DEVICE, AND PRODUCING METHOD OF OPTICAL ELEMENT COVERING MEMBER

(75) Inventors: Hiroshi Hayashi, Miyagi (JP); Yoshiyuki Maekawa, Hokkaido (JP); Masami Miyake, Miyagi (JP); Jiro Nozaki, Miyagi (JP); Katsuyoshi Ushizawa, Miyagi (JP); Masayasu Kakinuma, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/189,539

(22) Filed: Aug. 11, 2008

(30) Foreign Application Priority Data
Sep. 21, 2007 (JP) 2007-246293

(51) Int. Cl. G02F 1/1333; B29C 65/00; G02B 23/16; B60Q 3/04

(52) U.S. Cl. 349/58; 156/85; 359/511; 362/362

(57) ABSTRACT

An optical element covering member, and a backlight and a liquid crystal display device which use the optical element covering member are disclosed. The optical element covering member includes an optical element stacked member including one or more optical elements and a support medium for supporting the one or more optical elements, and a covering member for covering the optical element stacked member. The optical element stacked member covered with the covering member has at least one hole portion formed in an outer edge portion thereof.

### CROSS-REFERENCE TO RELATED APPLICATIONS

The present application claims priority to Japanese patent Application No. 2007-246293 filed in the Japanese Patent Office on Sep. 21, 2007, the entire disclosure of which is incorporated herein by reference.

### BACKGROUND

The present disclosure relates to an optical element covering member, and a backlight and a liquid crystal display device each including the optical element covering member, and a method for producing the optical element covering member.

In liquid crystal display devices, a large number of optical elements have been used for the purpose of improving the viewing angle and brightness. With respect to the optical elements, those in the form of a film or sheet, such as diffuser films and prism sheets, are used.

FIG. 26 shows the construction of a known liquid crystal display device. This liquid crystal display device includes, as shown in FIG. 26, a lighting device 101 for emitting light, a diffuser plate 102 for diffusing the light emitted from the lighting device 101, a plurality of optical elements 103 for, e.g., condensing or diffusing the light diffused by the diffuser plate 102, and a liquid crystal panel 104.

In recent years, the increasing the size of an image display device has a tendency to increase the weight or size of the optical element used in the display device. The optical element increased in weight or size is lacking in stiffness, so that the optical element suffers deformation. Such deformation of the optical element adversely affects the optical directivity to the display surface, leading to a serious problem in that the brightness irregularity occurs.

For solving the problem, a method in which the optical element is increased in thickness to improve the stiffness of the optical element has been proposed. However, the liquid crystal display device using such an optical element is increased in thickness, making it difficult to achieve advantages of the liquid crystal display device in that the display device is thin and lightweight. On the other hand, a method in which the individual optical elements are bonded together using a transparent adhesive to improve the stiffness of the optical elements in the form of a sheet or film has been proposed (see, for example, Japanese Unexamined Patent Application Publication No. 2005-301147 (patent document 1)).

However, the technique described in patent document 1 has a problem in that bonding the optical elements with a transparent adhesive inevitably increases the thickness of the resultant liquid crystal display device, though the increase of the display device thickness is smaller than the increase caused in the above method in which the optical element is increased in thickness. Further, the transparent adhesive possibly causes the display properties of the liquid crystal display device to be poor.

Accordingly, it is desirable to provide an optical element covering member which is advantageous in that it can improve the optical element in stiffness while preventing an increase of the thickness of a liquid crystal display device and preventing deterioration of the display properties of a liquid crystal display device, a backlight and a liquid crystal display device each including the same, and a method for producing an optical element covering member.

### SUMMARY

In an embodiment, an optical element covering member including an optical element and a support medium covered with a covering member is provided, thereby improving the optical element in stiffness while preventing an increase of the thickness of a liquid crystal display device and preventing deterioration of the display properties of a liquid crystal display device.

With respect to the covering member of the optical element covering member, a material, such as a film having heat shrinkability, is used, and the optical element covering member is subjected to a heat treatment by a shrink method, making it possible to improve the adhesion of the optical element and support medium to the covering member.

A general shrink method is described with reference to FIG. 27. As shown in FIG. 27, an optical element covering member 110 containing therein an optical element and a support medium is placed on a conveyer 113, and transported to the inside of a heating oven 112. In the heating oven 112, the optical element covering member 110 is exposed to hot air to cause it to shrink, so that the optical element and the covering member adhere to each other.

According to an embodiment, in the heat treatment performed by the method shown in FIG. 27, a displacement of position is caused between the optical element and the support medium within the covering member (hereinafter, frequently referred to as “position displacement”). When the optical element covering member suffering such position displacement is mounted on an actual display device, distortion is caused to lower the quality of display screen.

In this situation, studies have been made with a view toward preventing the occurrence of position displacement in the heat treatment for the optical element covering member.

As a result, it has been found that a method for producing an optical element covering member, in which a hole portion is formed in the outer edge portion of an optical element covering member and the package is subjected to heat treatment in a state such that a fixing member is engaged with the hole portion, is effective.

The present embodiments are, based on the above finding.

In accordance with a first aspect, there is provided an optical element covering member which includes an optical element stacked member including one or more optical elements and a support medium for supporting the one or more optical elements, and a covering member for covering the optical element stacked member. The optical element stacked member covered with the covering member has at least one hole portion formed in an outer edge portion thereof.

In accordance with a second aspect, there is provided a backlight which includes a light source for emitting light, a housing portion of containing the light source, and an optical element covering member provided in the housing portion. The optical element covering member includes an optical element stacked member which includes one or more optical elements and a support medium for supporting the one or more optical elements. The optical element stacked member covered with the support medium has at least one hole portion formed in an outer edge thereof. The housing portion has at least one protrusion formed therein. The protrusion formed in the housing portion is fitted into the hole portion formed in the optical element covering member.

In accordance with a third aspect, there is provided a liquid crystal display device which includes a backlight and a liquid crystal distal panel for displaying an image. The backlight includes a light source for emitting light, a housing portion for containing the light source therein, and an optical element covering member provided in the housing portion. The optical element covering member includes an optical element stacked member which includes one or more optical elements and a support medium for supporting the one or more optical elements. The optical element stacked member covered with the support medium has at least one hole portion formed in an outer edge thereof. The housing portion has at least one protrusion formed therein. The protrusion formed in the housing portion is fitted into the hole portion formed in the optical element covering member.

In accordance with a fourth aspect, there is provided a method for producing an optical element covering member, wherein the method includes the steps of covering one of more optical elements and a support medium for supporting the optical element with a covering member to prepare an optical element covering member, and subjecting the optical element covering member to a heat treatment so as to cause the support medium to shrink. The heat treatment is conducted while engaging a fixing member with a hole portion formed in an outer edge portion of the optical element covering member.

According to embodiments, one or more optical elements and a support medium are covered with a covering member, whereby the one or more optical elements and the support medium are integrated into a single component. As a result, the support medium can compensate for a lack of stiffness of the optical element.

According to embodiments, the heat treatment for the optical element covering member is conducted while engaging a fixing member is engaged with a hole portion formed in the outer edge portion of the optical element covering member. As a result, the position displacement between the optical element and the support medium caused during the heat treatment can be suppressed.

Additional features and advantages are described herein, and will be apparent from the following Detailed Description and the figures.

### BRIEF DESCRIPTION OF THE FIGURES

FIG. 1 is a diagrammatic view showing an example of the construction of a liquid crystal display device according to a first embodiment.

FIGS. 2A and 2B are perspective views showing the first example of the construction of an optical element covering member according to the first embodiment.

FIG. 3 is a cross-sectional view showing a first example of a bonding portion of the support medium in the first embodiment.

FIG. 4 is a cross-sectional view showing a second example of a bonding portion of the support medium in the first embodiment.

FIGS. 5A and 5B are perspective views showing another example of the construction of an optical element covering member according to the first embodiment.

FIGS. 6A and 6B are perspective views showing other examples of the construction of the corner portion of an optical element stacked member in the first embodiment.

FIGS. 7A and 7B are diagrammatic views for explaining an example of arrangement of an optical element covering member according to the first embodiment with respect to the backlight chassis.

FIGS. 8A and 8B are diagrammatic views for explaining other examples of arrangements of an optical element covering member according to the first embodiment with respect to the backlight chassis.

FIGS. 9A and 9B are diagrammatic views for explaining an example in which an optical element covering member is not fixed to the backlight chassis.

FIG. 10 is a diagrammatic view for explaining the thermal expansion of an optical element covering member according to the first embodiment

FIGS. 11A and 11B are diagrammatic views for explaining the size of a backlight chassis in the case where an optical element covering member is not fixed to the backlight chassis.

FIG. 12 is a diagrammatic view for explaining the size of a backlight chassis in the case where an optical element covering member is fixed to the backlight chassis.

FIG. 13 is a perspective view for explaining the first example of a method for producing an optical element covering member according to the first embodiment.

FIG. 14 is a perspective view for explaining the first example of a method for producing an optical element covering member according to the first embodiment.

FIG. 15 is a diagrammatic view for explaining the state of an optical element covering member according to the first embodiment, which is being heated.

FIGS. 16A and 16B are diagrammatic views showing an example of the temperature and air flow in a heating oven in a method for producing an optical element covering member according to the first embodiment.

FIGS. 17A to 17C are diagrammatic views showing other examples of the air flow in a heating oven in a method for producing an optical element covering member according to the first embodiment.

FIGS. 18A and 18B are diagrammatic views for explaining the first example of a method for producing an optical element covering member according to the first embodiment.

FIGS. 19A and 19B are diagrammatic views for explaining another example of a method for producing an optical element covering member according to the first embodiment.

FIG. 20 is a diagrammatic view for explaining another example of a method for producing an optical element covering member according to the first embodiment.

FIG. 21 is a diagrammatic view for explaining the second example of a method for producing an optical element covering member according to the first embodiment.

FIG. 22 is a perspective view showing an example of the construction of a backlight according to the second embodiment.

FIG. 23 is a perspective view showing an example of the construction of a backlight according to a third embodiment.

FIG. 24 is a diagrammatic view for explaining the place for measurement of position displacement of the optical element covering member in the Example.

FIG. 25 is a diagrammatic view for explaining the place for measurement of warpage of the optical element covering member in the Example.

FIG. 26 is a diagrammatic view showing the construction of a known liquid crystal display device.

FIG. 27 is a diagrammatic view for explaining a known heat treatment.

### DETAILED DESCRIPTION

Hereinbelow, embodiments will be described with reference to the accompanying drawings. In the following embodiments, in the all drawings, like parts or portions are indicated by like reference numerals.

### (1) First Embodiment

(1-1) Construction of Liquid Crystal Display Device

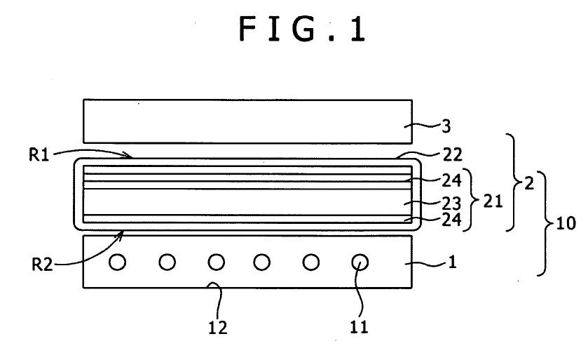

FIG. 1 shows an example of the construction of a liquid crystal display device according to a first embodiment. The liquid crystal display device includes, as shown in FIG. 1, a backlight 10 for emitting light, and a liquid crystal panel 3 for displaying an image based on the light emitted from the backlight 10. The backlight 10 includes a lighting device 1 for emitting light, and an optical element covering member 2 for improving the properties of the light emitted from the lighting device 1 and emitting the resultant light toward the liquid crystal panel 3. Hereinafter, in optical members including the optical element covering member 2, a side which the light from the lighting device 1 enters is referred to as “incident surface”, a side which emits the light from the incident surface is referred to as “transmission surface”, and a side positioned between the incident surface and the transmission surface is referred to as “edge face”. The incident surface and transmission surface are, frequently, collectively referred to as “principal surface”.

The lighting device 1 and optical element covering member 2 are integrated into one component by, for example, a backlight chassis as a housing, which is not shown in FIG. 1. An example of arrangement of the optical element covering member 2 with respect to the backlight chassis is described later.

The lighting device 1 is, for example, a direct under type lighting device, and includes at least one light source 11 for emitting light, and a reflector 12 for reflecting the light emitted from the light source 11 in the direction of the liquid crystal panel 3. With respect to the light source 11, there may be used, for example, a cold cathode fluorescent lamp (CCFL), a hot cathode fluorescent lamp (HCFL), an organic electroluminescence (OEL), an inorganic electroluminescence (EL), or a light emitting diode (LED). The reflector 12 is formed so as to cover, for example, the bottom and side of the at least one light source 11, and reflects the light emitted from the bottom and side of the at least one light source 11 in the direction of the liquid crystal panel 3.

The optical element covering member 2 includes at least one optical element 24 for, for example, diffusing or condensing the light emitted from the lighting device 1 to change the properties of the light, a support medium 23 for supporting the at least one optical element, and a covering member 22 for covering the at least one optical element 24 and support medium 23 to integrate them into one component. The optical element 24 is formed on at least one of the incident surface and the transmission surface of the support medium 23. Hereinafter, a component including the support medium 23 and at least one optical element 24 which are stacked on one another is referred to as “optical element stacked member 21”. In the outer edge portion of the optical element covering member 2 on the side of the principal surface, at least one hole portion for fixing the package to a backlight chassis(not shown) is formed.

With respect to the number or type of the optical element 24, there is no particular limitation, and the number or type of the optical element may be appropriately selected depending on desired properties of a liquid crystal display device. With respect to the optical element 24, for example, an optical element including the support medium 23 and at least one functional layer may be used. The optical element may include only a functional layer without a support medium. With respect to the optical element 24, for example, a light diffuser element, a light condenser element, a reflection-type polarizer, a polarizer, or a light dividing element may be used. The optical element 24 in the form of, for example, a film, sheet, or plate may be used. The optical element 24 preferably has a thickness of 5 to 3,000 μm, more preferably 25 to 1,000 μm. With respect to the thickness of each optical element 24, when the optical elements 24 are stacked, by covering both the optical elements and the support medium 23, the thickness may be reduced by about 20 to 50 percent.

The support medium 23 is, for example, a transparent plate which transmits the light emitted from the lighting device 1, or an optical plate for diffusing or condensing the light emitted from the lighting device 1 to change the properties of the light. With respect to the optical plate, for example, a diffuser plate, a phase contrast plate, or a prism plate may be used. The support medium 23 has a thickness of, for example, 1,000 to 50,000 μm. The support medium 23 is preferably composed of, for example, a polymer material having a transmittance of 30% or more. The order of stacking the optical element 24 and support medium 23 is appropriately selected depending on, for example, the functions of the optical element 24 and support medium 23. For example, when the support medium 23 is a diffuser plate, the support medium 23 is disposed on the side into which the light from the lighting device 1 enters. When the support medium 23 is a reflection-type polarizing plate, the support medium 23 is disposed on the side which emits light to the liquid crystal panel 3. The forms of the incident surface and transmission surface of the optical element 24 and support medium 23 are appropriately selected depending on the form of the liquid crystal panel 3, and are, for example, a rectangle having an aspect ratio which is not 1. The support medium 23 preferably has appropriate stiffness, and, as a material for the support medium, a material having an elastic modulus of about 1.5 GPa or more at room temperature is suitable, and examples include polycarbonate, polymethyl methacrylate, polystyrene, cycloolefin resins {e.g., ZEONOR (registered trademark)}, and glass.

It is preferred that the principal surface of each of the optical element 24 and the support medium 23 is roughened or contains fine particles. In this case, rubbing or friction of the principal surface can be suppressed. With respect to each of the optical element 24 and the support medium 23, if desired, an additive, such as a light stabilizer, an ultraviolet light absorber, an antistatic agent, a flame retardant, or an antioxidant, can be added to impart an ultraviolet light absorbing ability, an infrared absorbing ability, a destaticizing ability, or the like to the optical element 24 and support medium 23. Alternatively, each of the optical element 24 and the support medium 23 may be subjected to surface treatment, such as anti-reflection treatment (AR treatment) or anti-glare treatment (AG treatment) to suppress diffusion of the reflected light or reduce the reflected light. Further alternatively, the surface of each of the optical element 24 and the support medium 23 may have imparted an ability to reflect ultraviolet light or infrared ray.

The covering member 22 is composed of, for example, a single or multilayer film, or single or multilayer sheet, which has a transparency. The covering member 22 has, for example, a bag form, and all sides of the optical element stacked member 21 are covered with the covering member 22. Alternatively, the covering member 22 may be composed of a film(s) having the optical element stacked member 21 disposed therebetween and having the ends put on one another and bonded together so that the two sides, three sides, or four sides of the covering member 22 are closed. Specifically, examples of the covering members 22 having two sides closed include a covering member composed of a strip-form film or sheet having bonded together the ends as viewed in the longitudinal direction, and a covering member composed of two rectangular films or sheets which are put on one another and which have the opposite two sides bonded together. Examples of the covering members 22 having three sides closed include a covering member composed of a strip-form film or sheet which is folded so that the ends as viewed in the longitudinal direction are put on one another and the two sides are bonded together, and a covering member composed of two rectangular films or sheets which are put on one another and which have the three sides bonded together. Examples of the covering members 22 having four sides closed include a covering member composed of a strip-form film or sheet which is folded so that the ends as viewed in the longitudinal direction are put on one another and the three sides are bonded together, and a covering member composed of two rectangular films or sheets which are put on one another and which have the four sides bonded together. Further alternatively, the covering member may be composed of two films having the optical element stacked member 21 disposed therebetween and having at least two sides of the ends of the two films bonded together by heat sealing. Hereinafter, with respect to the sides of the covering member 22, the side opposing the optical element stacked member 21 is referred to as “inner surface”, and the opposite side is referred to as “outer surface”. In the covering member 22, a region on the side of the incident surface which the light from the lighting device 1 enters is referred to as “first region R1”, and a region on the side of the transmission surface which emits light from the lighting device 1 to the liquid crystal panel 3 is referred to as “second region R2”.

The covering member 22 has a thickness of, for example, 5 to 5,000 μm, preferably 10 to 500 μm, more preferably 15 to 300 μm. If the covering member 22 has too large a thickness, the brightness is lowered, or shrinkage in the heat-sealed portion (sealed portion) of the covering member 22 is not uniform. Further, adhesion of the covering member to the optical element stacked member 21 is poor and hence wrinkles or the like are caused, and therefore, when the resultant optical element covering member is implemented on an actual display device, distortion is caused, leading to a lowering of the image quality. In the covering member 22, the thickness on the side of the incident surface may be different from the thickness on the side of the transmission surface. The covering member 22 may contain aggregate for improving the stiffness.

In the case of the covering member 22 having anisotropy, it is preferred that the covering member has smaller optical anisotropy. Specifically, the covering member preferably has a retardation of 50 nm or less, more preferably 20 nm or less. In the covering member 22, a monoaxially stretched or biaxially oriented sheet or film is preferably used. When such a sheet or film is used in the covering member, the application of heat enables the covering member 22 to shrink in the stretching direction, thus improving the adhesion between the covering member 22 and the optical element stacked member 21.

It is preferred that the covering member 22 has shrinkability. In this case, by applying heat to the support medium 22 stretched by heating, the support medium can exhibit heat shrinkability. Further, the edge face of the covering member 22 is stretched, and the ends of the covering member having disposed therein the support medium 23 and optical element 24 as contents are heat-sealed, enabling covering and shrinkage by using the stretchability.

With respect to the material for the covering member 22, there may be used preferably a polymer material having a heat shrinkability, more preferably a polymer material shrinkable by heating at room temperature to 85° C. since the temperature in a liquid crystal display device or the like is elevated to about 75° C. at the highest. With respect to the material for the covering member, there is no particular limitation as long as the material satisfies the above-mentioned requirement, and, specifically, polystyrene (PS), a copolymer of polystyrene and butadiene, polypropylene (PP), polyethylene (PE), casted polyethylene terephthalate (PET), polycarbonate (PC), a polyester resin, such as polyethylene naphthalate (PEN), a vinyl bond resin, such as polyvinyl alcohol (PVA), a cycloolefin resin, an urethane resin, a vinyl chloride resin, a natural rubber resin, and an artificial rubber resin may be used individually or in combination.

It is preferred that the heat shrinkage factor of the covering member 22 is appropriately selected depending on the size of or material for the support medium 23 or optical element 24 covered in the covering member or the environment in which the optical element stacked member 21 is used. Specifically, the covering member preferably has a shrinkage factor at 85° C. in the range of from 0.2 to 100%, more preferably 0.5 to 20%, further preferably 0.5 to 10%. If the shrinkage factor is less than 0.2%, the adhesion between the covering member 22 and the optical element 24 is likely to be poor. On the other hand, if the shrinkage factor is more than 100%, the in-plane heat shrinkability is likely to be uneven, causing the optical element to shrink. The covering member 22 preferably has a heat deformation temperature of 85° C. or higher. In this case, the optical element covering member 2 can be prevented from suffering deterioration of the optical properties due to heat generated by the light source 11. The material for the covering member 22 preferably has a loss in weight on drying of 2% or less. The material for the covering member 22 preferably has a refractive index (refractive index of the covering member 22) of 1.6 or less, more preferably 1.55 or less. If an optical functional layer is formed on the covering member 22 by shaping or transferring of shape, a higher refractive index exhibits remarkable effect, and the refractive index of the covering member is preferably 1.5 or more, more preferably 1.57 or more, the most preferably 1.6 or more, and it is desired that the refractive index is appropriately selected depending on the functional layer. A higher refractive index exhibits increased optical actions, and, for example, improves the condensing action, diffusing action, and the like.

It is preferred that the covering member 22 contains at least one type of filler. In this case, if the optical element covering members obtained are stacked on one another, it is possible to prevent the optical element covering members from sticking to each other. Further, the adhesion between the covering member 22 and the members contained therein can be appropriately controlled so that the covering member 22 and the members contained therein do not stick to each other. With respect to the filler, for example, at least one member selected from organic filler and inorganic filler may be used. With respect to the material for the organic filler, for example, at least one member selected from the group consisting of an acrylic resin, a styrene resin, fluorine, and hollow fine particles may be used. With respect to the inorganic filler, for example, at least one member selected from the group consisting of silica, alumina, talc, titanium oxide, and barium sulfate can be used. The filler in any form, such as a needle-like form, a spherical form, an ellipsoidal form, a plate form, or a flake form, can be used. With respect to the diameter of the filler, for example, one or more types of diameters may be selected.

Instead of the use of filler, a shape may be formed in the surface of the covering member. A method for forming such a shape includes a method in which, upon molding a shrinkable film or sheet for forming the covering member 22, an arbitrary diffusing shape is transferred to the surface of the film or sheet, and a method in which an arbitrary diffusing shape is transferred by heat and/or pressure to the surface of a molded film or sheet.

With respect to the covering member 22, if desired, an additive, such as a light stabilizer, an ultraviolet light absorber, an antistatic agent, a flame retardant, or an antioxidant, may be further added to impart an ultraviolet light absorbing ability, an infrared absorbing ability, a destaticizing ability, or the like to the covering member 22. Alternatively, the covering member 22 may be subjected to a surface treatment, such as anti-glare treatment (AG treatment) or anti-reflection treatment (AR treatment), to suppress diffusion of the reflected light or reduce the reflected light. Further alternatively, the covering member may have imparted an ability to transmit light in a specific wavelength region, such as UV-A light (about 315 to 400 nm).

The liquid crystal panel 3 spatially modulates the light supplied from the light source 11 to display the resultant information. With respect to the liquid crystal panel 3, there may be used a panel of a display mode, such as a twisted nematic (TN) mode, a super twisted nematic (STN) mode, a vertically aligned (VA) mode, an in-plane switching (IPS) mode, an optically compensated birefringence (OCB) mode, a ferroelectric liquid crystal (FLC) mode, a polymer dispersed liquid crystal (PDLC) mode, or a phase change guest host (PCGH) mode.

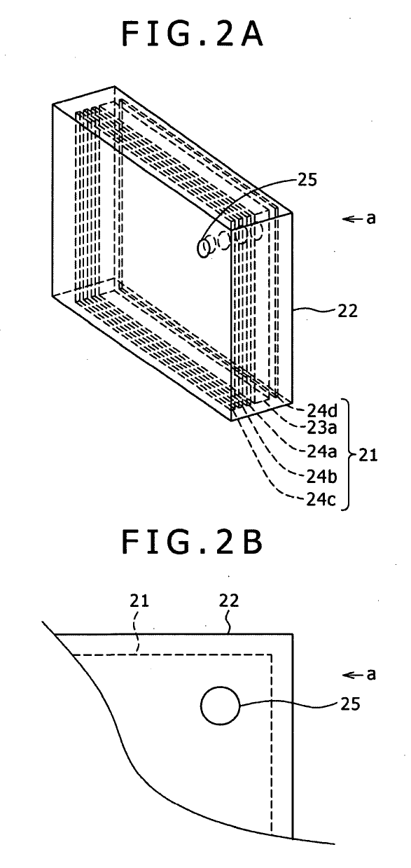

Next, examples of the construction of the optical element covering member 2 are described in detail with reference to FIGS. 2 to 4.

FIGS. 2A and 2B show an example of the construction of an optical element covering member according to a first embodiment. The optical element covering member 2 includes, as shown in FIG. 2, for example, a diffuser plate 23a as a support medium, a diffuser film 24a, a lens film 24b, and a reflection-type polarizer 24c as optical elements, and a covering member 22 for covering them to integrate them into one component. In this example, the diffuser plate 23a, diffuser film 24a, lens film 24b, and reflection-type polarizer 24c constitute an optical element stacked member 21. The principal surface of the optical element stacked member 21 has a form of, for example, rectangle having an aspect ratio which is not 1. The covering member 22 has, for example, a bag form, and the front surface of the optical element stacked member 21 is covered with the covering member 22. The covering member 22 is bonded, for example, on the edge face of the optical element stacked member 21.

In the outer edge portion of the optical element covering member 2 is formed a hole portion 25. FIG. 2B shows an enlarged view of the portion indicated by an arrow a in FIG. 2A. The hole portion 25 is a hole which is formed in the incident surface and transmission surface of the optical element covering member 2, and which passes through the optical element covering member 2. The holes respectively formed in the optical element stacked member 21 and the covering member 22 combine to form the hole portion 25. The hole portion 25 is, for example, in a circular form as shown in FIG. 2B, but the form of the hole portion is not limited to this.

The diffuser plate 23a is provided above at least one light source 11, and diffuses the light emitted from the at least one light source 11 and the light reflected by the reflector 12 so that the luminance is uniform. With respect to the diffuser plate 23a, there may be used, for example, a diffuser plate having on the surface an uneven structure for diffusing light, a diffuser plate containing fine particles or the like having a refractive index different from that of the main constituent of the diffuser plate 23a, a diffuser plate containing hollow fine particles, or a diffuser plate using at least two of the uneven structure, fine particles, and hollow fine particles in combination. With respect to the fine particles, for example, at least one member selected from organic filler and inorganic filler may be used. The uneven structure, fine particles, or hollow fine particles are formed on, for example, the transmission surface of the diffuser film 24a. The diffuser plate 23a has a light transmittance of, e.g., 30% or more.

The diffuser film 24a is provided on the diffuser plate 23a, and further diffuses the light diffused by the diffuser plate 23a. With respect to the diffuser film 24a, there may be used, for example, a diffuser film having on the surface an uneven structure for diffusing light, a diffuser film containing fine particles or the like having a refractive index different from that of the main constituent of the diffuser film 24a, a diffuser film containing hollow fine particles, or a diffuser film using at least two of the uneven structure, fine particles, and hollow fine particles in combination. With respect to the fine particles, for example, at least one member selected from organic filler and inorganic filler may be used. The uneven structure, fine particles, or hollow fine particles are formed on, for example, the transmission surface of the diffuser film 24a.

The lens film 24b is provided on the diffuser film 24a, and improves, e.g., directivity of the light emitted. The lens film 24b has a row of fine prisms or lenses, for example, on the transmission surface. The prisms or lenses individually have a cross-section of, e.g., a substantially triangular form, taken along the row direction, and preferably have their apexes rounded. In this case, the cut-off properties can be improved, thus achieving the wide viewing angle.

The diffuser film 24a and lens film 24b are individually composed of, for example, a polymer material having a refractive index of, e.g., 1.5 to 1.6. With respect to the material for the optical element 24 or the material constituting the optical functional layer formed on the optical element, for example, an ionizing photosensitive resin curable by irradiation with a ray of light or an electron beam, a thermoplastic resin or thermosetting resin curable by heat, or an ultraviolet curing resin curable by irradiation with ultraviolet light is preferred.

The reflection-type polarizer 24c is provided on the lens film 24b, and, with respect to the light improved in directivity by the lens film 24b, permits one of the polarized components at right angles to pass through it and reflects another. The reflection-type polarizer 24c is composed of a stacked member, such as an organic multilayer film, an inorganic multilayer film, or a liquid crystal multilayer film. The reflection-type polarizer 24c may contain a material having a refractive index different from that of the polarizer. A diffusion layer or lens may be formed on the reflection-type polarizer 24c.

A light control film 24d includes an optical functional layer having a rough surface in at least one of the incident surface and the transmission surface, and is formed for controlling the light source irregularities of a CCFL or an LED. For example, a prism form, a circular arc form, a continuous hyperboloidal or paraboloidal form, a triangle composed of the above form, a combination thereof, or a structure having a flat surface, or a film, such as a diffuser film 24a, may be provided.

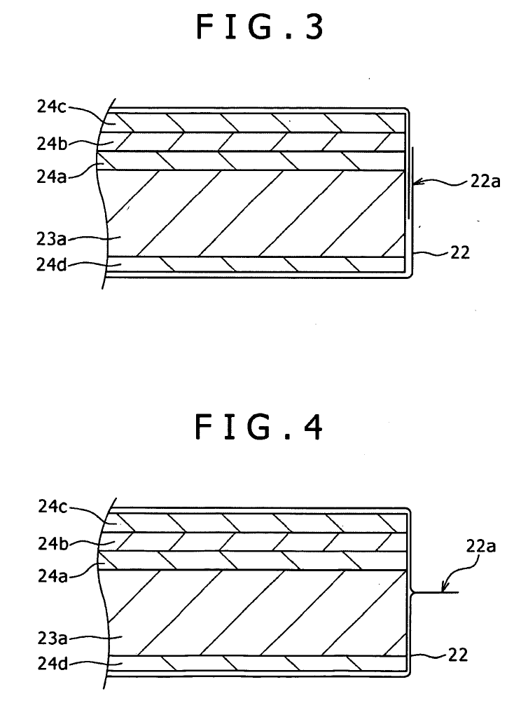

Examples of bonding portions of the support medium 22 are described with reference to FIGS. 3 and 4.

FIG. 3 shows the first example of a bonding portion of the support medium. In the first example, as shown in FIG. 3, the ends of the support medium are bonded together on the edge face of the optical element stacked member 21 so that the inner surface and outer surface of the ends face each other. That is, the ends of the support medium 22 are bonded together so that the ends bonded follow the edge face of the optical element stacked member 21.

FIG. 4 shows the second example of a bonding portion of the covering member. In the second example, as shown in FIG. 4, the ends of the covering member are bonded together on the edge face of the optical element stacked member 21 so that the individual inner surfaces of the ends face each other. That is, the ends of the support medium 22 are bonded together so that the ends bonded protrude from the edge face of the optical element stacked member 21.

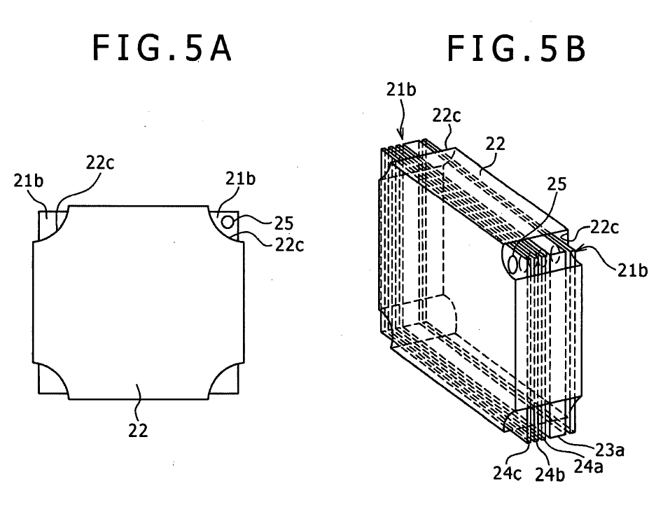

FIGS. 5A and 5B show another example of the construction of an optical element covering member. In this example, with respect to the optical element covering member 2 shown in FIG. 2, at least one opening 22c is formed in the covering member 22. The opening is formed in, for example, at least one portion of corner portions 21b of the optical element stacked member 21. In this example, by virtue of the at least one opening 22c formed in the covering member 22, air in the covering member 22 can be emitted through the opening 22c during shrinking of the support medium 22 in the process for producing the optical element covering member 2, thus preventing the covering member 22 from, e.g., expanding. When the covering member expands and the resultant optical element covering member is mounted on an actual display device, distortion is caused, leading to a lowering of the image quality. Further, the covering member 22 can be prevented from suffering breakage. The opening serves as an emission outlet for air upon heat shrinking, and, after mounted on a liquid crystal display device, the opening serves as an emission outlet for air expanded due to heat or an emission outlet for air generated from the optical element stacked member 21.

As shown in FIG. 5, the corner portion 21b of the optical element stacked member 21 is exposed through the opening 22c in the optical element covering member 2. A hole portion 25 is formed in the corner portion 21b. The hole portion 25 is a hole which passes through the corner portion 21b, and holes respectively formed in the optical element 24 and the support medium 23 combine to form the hole portion 25.

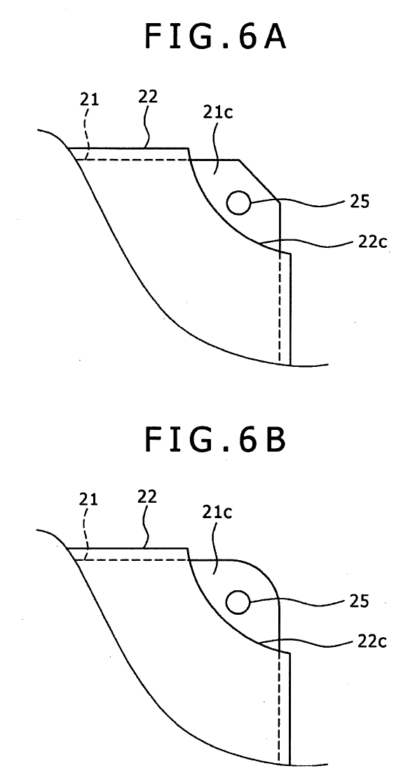

FIGS. 6A and 6B show other examples of the corner portion 21b of the optical element stacked member 21. The corner portion 21c shown in FIG. 6A corresponds to the corner portion 21b shown in FIG. 5, of which tip is cut out. The corner portion 21d shown in FIG. 6B corresponds to the corner portion 21b shown in FIG. 5, of which tip is rounded. When the corner portion has a tip having an obtuse angle, in the shrinking step in the production process, a flaw caused by friction due to contact between the tip of the corner portion 21c and the covering member 22 can be prevented, and the reduction of friction suppresses position displacement.

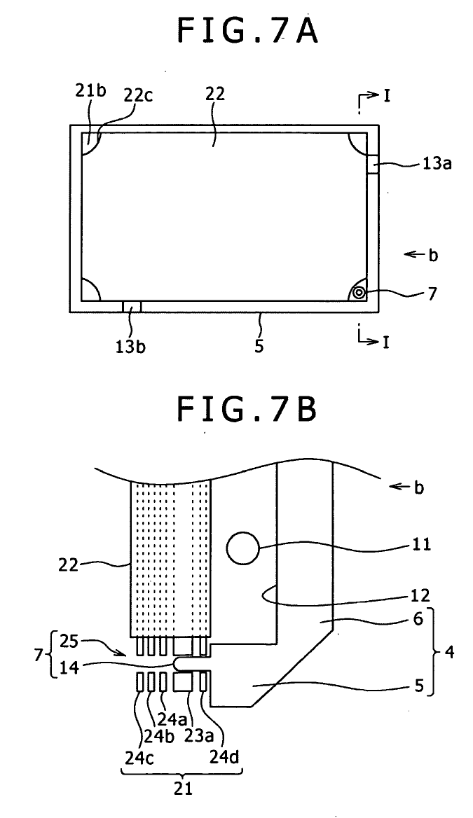

Examples of arrangements of the optical element covering member 2 with respect to the backlight chassis as a housing portion are described below. FIGS. 7 to 10 show examples in which the opening 22c is formed in the covering member 22 as shown in FIG. 5.

FIG. 7A is a front view of the optical element covering member 2 fixed to a backlight chassis 4, and FIG. 7B is an enlarged cross-sectional view of the portion indicated by an arrow b shown in FIG. 7A, taken along the line I-I. As shown in FIG. 7, the side of the backlight chassis 4 on which the light source 11 and reflector 12 are provided faces the incident surface of the optical element covering member 2.

The backlight chassis 4 includes, for example, a principal surface 6 in the form of a rectangle having an aspect ratio which is not 1, and an outer edge portion 5 provided at the edge of the principal surface 6 so that it forms a sidewall. The length and width of the outer edge portion 5 are respectively large, as compared to the length and width of the principal surface of the optical element covering member 2, and, even when the optical element covering member 2 suffers thermal expansion, the size of the optical element covering member 2 is not larger than that of the outer edge portion 5.

As shown in FIG. 7A, a fitting portion 7 is formed at the corner portion of the outer edge portion 5 and optical element covering member 2. As shown in FIG. 7B, a protrusion 14 formed in the side of the outer edge portion 5 opposing the optical element covering member 2 is fitted into the hole portion 25 formed in the optical element covering member 2 to constitute the fitting portion 7. The protrusion 14 is a protrusion in a needle-like form or rod form, which can be fitted into the hole portion 25. By virtue of the fitting portion 7, the optical element covering member 2 is fixed to the backlight chassis 4 at a specific position. Hereinafter, the end of the outer edge portion 5 on the side opposing the optical element covering member 2 is frequently referred to as “opposing surface”.

In the outer edge portion 5, on the edge on which the protrusion 14 is formed and an edge adjacent to this edge are, respectively, provided a supporting portion 13a and a supporting portion 13b. The supporting portion 13a and supporting portion 13b individually have, e.g., a substantially cuboidal shape, and protrude from the opposing surface of the outer edge portion 5. The supporting portions 13a and 13b are in contact with the optical element covering member 2 at the edge face of the long side and the edge face of the short side to support the optical element covering member 2.

The optical element covering member 2 may be fixed by the fitting portion 7 and fixing portions 13a and 13b and disposed in the backlight chassis 4 at a specific position.

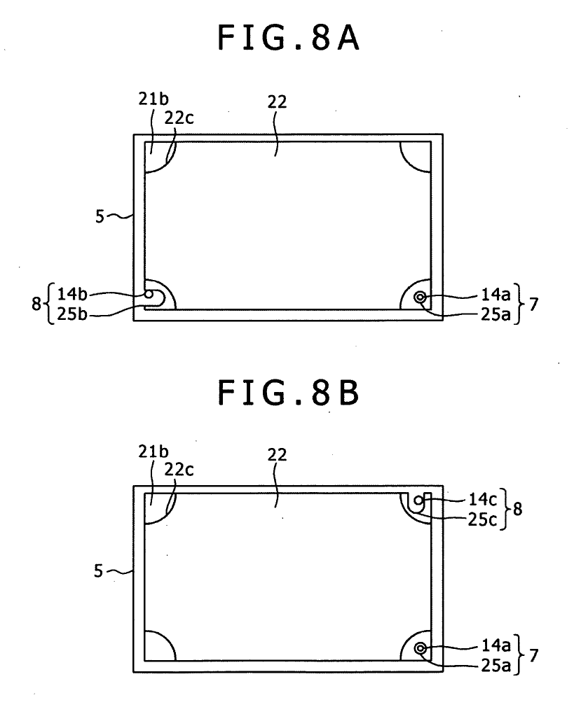

Other examples of arrangements of the optical element covering member 2 are described with reference to FIGS. 8A and 8B. The optical element covering member 2 shown in FIG. 8A has a hole portion 25a formed in one of corner portions 21b, and a hole portion 25b formed in a corner portion 21b adjacent to the corner portion 21b having formed the hole portion 25a in the direction of the long side. The protrusion 14a formed on the outer edge portion 5 of the backlight chassis 4 is fitted into the hole portion 25a to form a fitting portion 7. By virtue of the fitting portion 7, the optical element covering member 2 is fixed to the backlight chassis 4 at a specific position.

The hole portion 25b is a notch having an opening, for example, in the short side of the optical element covering member 2. In the present specification, the notch having an opening shown in FIG. 8A is included in the hole portion. The hole portion 25b is engaged with a protrusion 14b formed on the outer edge portion 5 of the backlight chassis 4 to form an engagement portion 8, supporting the optical element covering member 2.

It is preferred that the hole portion 25b is engaged with the protrusion 14b in a state such that the protrusion can be moved in the hole portion. In this case, even if the optical element covering member 2 suffers thermal expansion, the long side of the optical element covering member 2 can be prevented from being crooked due to contact of the protrusion 14b with the hole portion 25b.

The optical element covering member 2 shown in FIG. 8B has a hole portion 25a formed in one of corner portions 21b, and a hole portion 25c formed in a corner portion 21b adjacent to the corner portion 21b having formed the hole portion 25a in the direction of the short side. The protrusion 14a is fitted into the hole portion 25a to form the fitting portion 7.

Like the hole portion 25b, the hole portion 25c is a notch having an opening, for example, in the long side of the optical element covering member 2. The hole portion 25c is engaged with a protrusion 14c formed on the outer edge portion 5 of the backlight chassis 4 to form an engagement portion 8, supporting the optical element covering member 2.

It is preferred that the hole portion 25c is engaged with the protrusion 14c in a state such that the protrusion can be moved in the hole portion. In this case, even if the optical element covering member 2 suffers thermal expansion, the short side of the optical element covering member 2 can be prevented from being crooked due to the contact of the protrusion 14c with the hole portion 25c.

Each of the hole portion 25b and the hole portion 25c may be a hole portion having no notch at the end (not shown). In this case, the hole portion 25b and hole portion 25c individually have, for example, an elliptic form having a major axis in the direction of thermal expansion of the optical element covering member 2, thus preventing the optical element covering member 2 from being crooked due to thermal expansion.

Next, the effect of fixing the optical element covering member 2 to the backlight chassis 4 is described in detail.

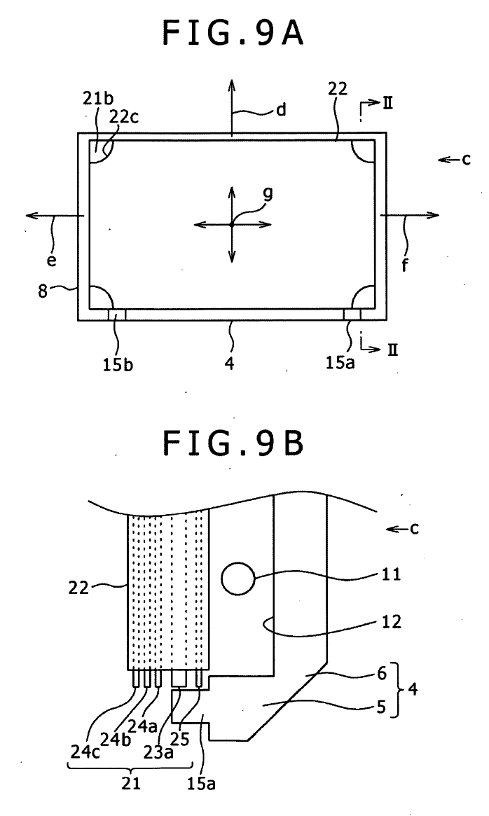

An example in which the optical element covering member 2 has no hole portion 25 and is not fixed to the backlight chassis 4 is first described with reference to FIGS. 9A and 9B.

FIG. 9A is a front view of the optical element covering member 2 placed on the backlight chassis 4, and FIG. 9B is an enlarged cross-sectional view of the portion indicated by an arrow c shown in FIG. 9A, taken along the line II-II. As shown in FIG. 9A, on the opposing surface of one edge of the outer edge portion 5 are formed a set portion 15a and a set portion 15b. The set portion 15a and set portion 15b individually have, e.g., a substantially cuboidal shape, and protrude from the opposing surface of the outer edge portion 5 as shown in FIG. 9B. The optical element covering member 2 is set on the set portion 15a and set portion 15b and disposed in the backlight chassis 4.

In FIG. 9A, an arrow d, an arrow e, and an arrow f indicate directions of expansion of the optical element covering member 2. The optical element covering member 2 has different degrees of expansion in its individual portions. For example, a portion of the optical element covering member positioned near a circuit (not shown) or the like is more likely to be heated to a high temperature than other portions, and, in such a portion, the degree of expansion of the optical element covering member 2 is larger. Accordingly, when the optical element covering member 2 is not fixed to the backlight chassis 4 as shown in FIG. 9A, for example, a predetermined site g on the optical element covering member 2 can move in both the long side direction (horizontal direction as viewed on the figure) and the short side direction (vertical direction as viewed on the figure) of the optical element covering member 2.

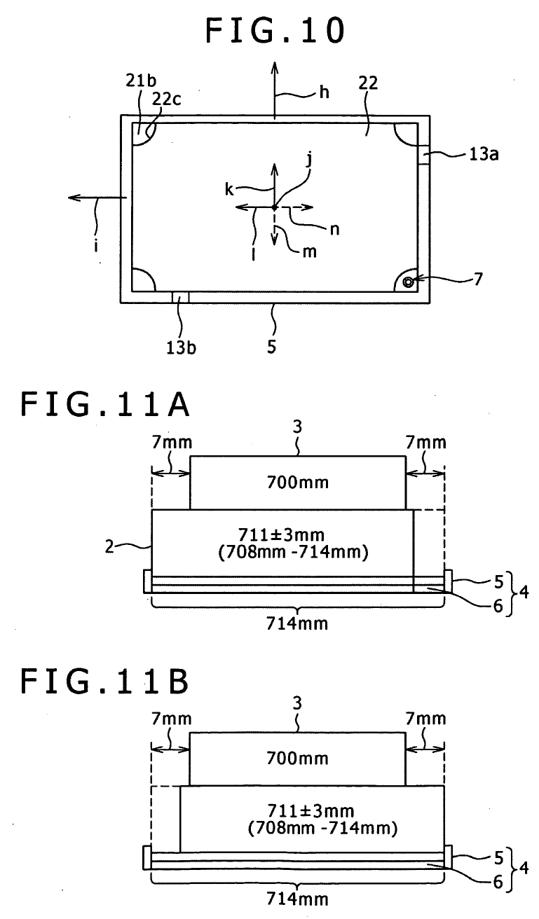

In contrast, when the corner portion 21b of the optical element stacked member 21 is fixed by the fitting portion 7 and the optical element covering member 2 is supported by the supporting portion 13a and supporting portion 13b as shown in FIG. 10, the directions of expansion of the optical element covering member 2 are indicated by an arrow h and an arrow i shown in FIG. 10. In this case, for example, a predetermined site j on the optical element covering member 2 moves in the directions of the arrow h and arrow i, but it does not move in directions indicated by dotted lines of an arrow m and an arrow n, i.e., directions different from the direction of expansion.

Thus in the optical element covering member 2 fixed to the backlight chassis 4, the movable direction can be restricted, as compared to that in the optical element covering member which is not fixed. Accordingly, alignment of the light control film 24d according to the pitch of the lighting device 11 is possible, enabling design of a thinner liquid crystal display device.

Next, with respect to the optical element covering member 2 which is not fixed to or is fixed to the backlight chassis 4, a required size of the backlight chassis 4 is individually described. An explanation is made on the size of the long side (width) of the backlight chassis 4 as an example.

The case where the optical element covering member 2 is not fixed to the backlight chassis 4 is first described with reference to FIGS. 11A and 11B. FIG. 11A is a diagrammatic view of the optical element covering member 2 which have moved in the direction to the left of FIG. 11A, and FIG. 11B is a diagrammatic view of the optical element covering member 2 which have moved in the direction to the right of FIG. 11B.

The liquid crystal panel 3 has an effective screen having a width of, for example, 700 mm, and thermal expansion of the optical element covering member 2 under presumed conditions at ±50° C. is ±3 mm (expansion size margin: 6 mm). The thermal expansion and size of the optical element covering member 2 respectively corresponds to the thermal expansion and size of the support medium 23a contained in the optical element covering member 2.

When the optical element covering member 2 moves in the direction to the left as shown in FIG. 11A, a width of 7 mm at the least is needed on the right-hand side of the effective screen. A portion in which the optical element covering member 2 and the effective screen of the liquid crystal panel 3 do not overlap secures a size of 1 mm at the least, and the value of the above width is determined from the sum of the size of this portion, i.e., 1 mm, and the expansion size margin of the optical element covering member 2, i.e., 6 mm.

Similarly, when the optical element covering member 2 moves in the direction to the right as shown in FIG. 11B, a width of 7 mm at the least is needed on the left-hand side of the effective screen.

As a result, the optical element covering member 2 requires a size of 711 mm, and the outer edge portion 5 of the backlight chassis 4 requires an inner size of 714 mm.

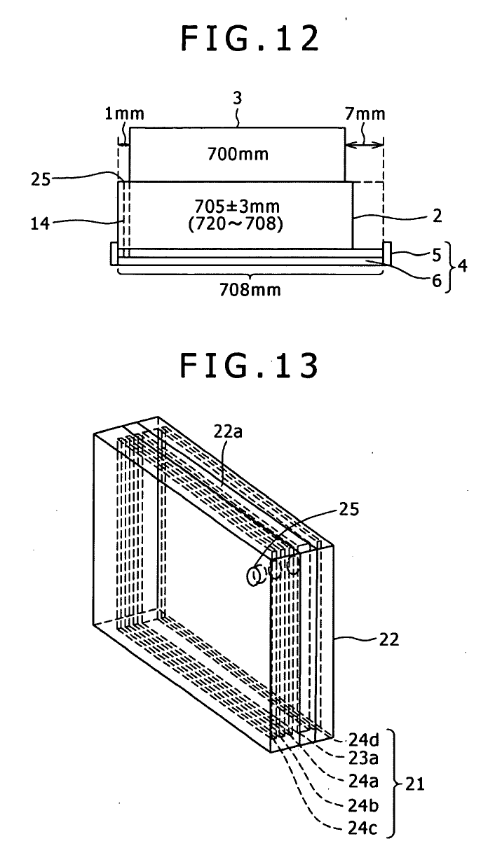

The case where the optical element covering member 2 is fixed to the backlight chassis 4 is described with reference to FIG. 12. Like FIG. 11, the liquid crystal panel 3 has an effective screen having a width of, for example, 700 mm, and thermal expansion of the optical element covering member 2 is ±3 mm (expansion size margin: 6 mm).

As shown in FIG. 12, when the protrusion 14 is fitted into the hole portion 25 to fix the optical element covering member 2 on the left-hand side as viewed in FIG. 12, a width of as least 7 mm is needed on the right-hand side of the effective screen of the liquid crystal panel 3. Like FIG. 11, a portion in which the optical element covering member 2 and the effective screen of the liquid crystal panel 3 do not overlap secures a size of at least 1 mm, and the value of the above width is determined from the sum of the size of this portion, i.e., 1 mm, and the expansion size margin of the optical element covering member 2, i.e., 6 mm.

On the other hand, no expansion size margin is needed on the side to which the optical element covering member 2 is fixed, namely, on the left-hand side of the effective screen, and therefore only a portion in which the optical element covering member 2 and the effective screen of the liquid crystal panel 3 do not overlap secures a size of 1 mm.

Accordingly, the optical element covering member 2 requires a size of 705 mm, and the outer edge portion 5 of the backlight chassis 4 requires an inner size of 708 mm. These values are small, as compared to those in the case where the optical element covering member 2 is not fixed to the backlight chassis 4 described above with reference to FIG. 11.

By fixing the optical element covering member 2 to the backlight chassis 4, it is possible to design the optical element covering member 2 and backlight chassis 4 so that their sizes are reduced, thus achieving a liquid crystal display device having a frame narrowed.

(1-2) Method for Producing an Optical Element Covering Member

### FIRST EXAMPLE

The first example of a method for producing an optical element covering member 2 having the above-described construction is described.

A diffuser plate 23a, a diffuser film 24a, a lens film 24b, and a reflection-type polarizer 24c are first placed in this order on a light control film 24d to obtain an optical element stacked member 21. It is preferred to use the diffuser plate 23a having a size (length and/or width) larger than the size (length and/or width) of the optical element 24 by about 1 to 2 mm. In this case, when the resultant optical element covering member is mounted on an actual display device, distortion is unlikely to occur, making it possible to prevent a lowering of the image quality. Then, a raw sheet of a film having heat shrinkability is prepared, and two rectangular films are cut from the raw sheet.

Then, the two films are put on each other, and the two sides or three sides of the films are heat-sealed to obtain a support medium 22 in a bag form. The above-obtained optical element stacked member 21 is inserted to the opened side, and then the support medium 22 is sealed up by heat-sealing the opened side to form a bonding portion 22a as shown in FIG. 13, thus obtaining an optical element covering member 2. Alternatively, the optical element covering member 2 may be obtained in such a way that a strip-form film is folded so that the ends of the film as viewed in the longitudinal direction are put on one another and the optical element stacked member 21 is inserted into the folded film and then, the support medium 22 is sealed up by heat-sealing the opened two sides, three sides, or four sides. Further alternatively, the optical element covering member 2 may be obtained in such a way that the optical element stacked member 21 is disposed between two films and the ends of the two films are heat-sealed together at two sides or more. In at least one outer edge portion of the optical element covering member 2 is formed a hole portion 25. With respect to the method for forming the hole portion 25, there is no particular limitation, and examples include perforation, drilling, and pressing.

Subsequently, heat is applied to the support medium 22 to cause the covering member 22 to heat-shrink. The heat shrinking is conducted in a state such that a fixing member is engaged with the hole portion 25 in the optical element covering member 2. The step for heat treatment of the optical element covering member 2 is described below in detail.

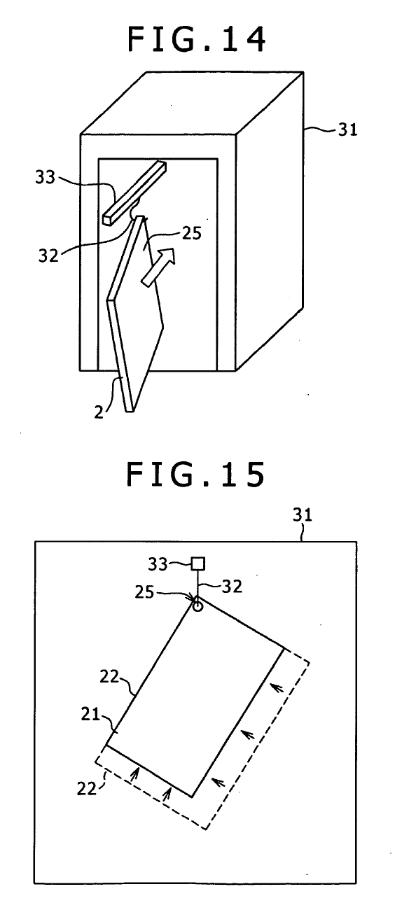

FIG. 14 shows an example of a heating apparatus. This heating apparatus includes a hanger 32 as a fixing member, a transport path 33 for transporting the optical element covering member 2 by moving the hanger 32, and a heating oven 31 into which the optical element covering member 2 is fed by the transport path 33.

The hanger 32 is composed of, for example, a metal in a needle-like form or a rod form which is thin such that the metal can penetrate the hole portion 25 in the optical element covering member 2. The hanger 32 has a curved end, and is engaged with the hole portion 25 in the optical element covering member 2, making it possible to hold the optical element covering member 2 in a state such that the optical element covering member is hanged. The hanger 32 has stiffness enough to hold the optical element covering member 2. With respect to the shape of the hanger 32, there is no particular limitation.

The transport path 33 is composed of a guide rail, such as a chain. Onto the guide rail is movably connected the hanger 32.

As shown in FIG. 14, the hanger 32 is engaged with the hole portion 25 in the optical element covering member 2, so that the optical element covering member 2 is hanged by the hanger 32. The hanger 32 serves as a fixing member to fix the optical element 24 and support medium 23. The optical element covering member is held in a state such that the principal surface of the optical element covering member 2 is substantially vertical, and the support medium 22 is moved in the direction indicated by an arrow shown in FIG. 14, namely, moved to the inside of the heating oven 31.

As shown in FIG. 15, in the heating oven 31, the support medium 22 fixed and hanged by the hanger 32 is subjected to a heat treatment. In the heat treatment, the covering member 22 is exposed to, for example, hot air. In FIG. 15, a covering member drawn with a dotted line indicates the covering member before subjected to heat treatment, and a covering member drawn with a solid line indicates the covering member which has been subjected to heat treatment. The heat treatment causes the covering member 22 to heat-shrink as indicated by arrows shown in FIG. 15 and to be brought into contact with the optical element stacked member 21. In this instance, the optical element covering member 2 is fixed by the hanger 32, and therefore the position displacement between the at least one optical element 24 and the support medium 23 covered in the covering member 22 can be prevented during the heat treatment. In addition, not only can the heating be conducted so that the temperature of the incident surface and that of the transmission surface are substantially the same, but also the optical element covering member 2 can be prevented from suffering warpage due to its own weight.

The heating temperature in the heating oven 31 is, for example, in the range of from 80 to 200° C. The heating time is appropriately selected depending on the heating temperature, for example, selected from the range of 3 seconds to 100 minutes.

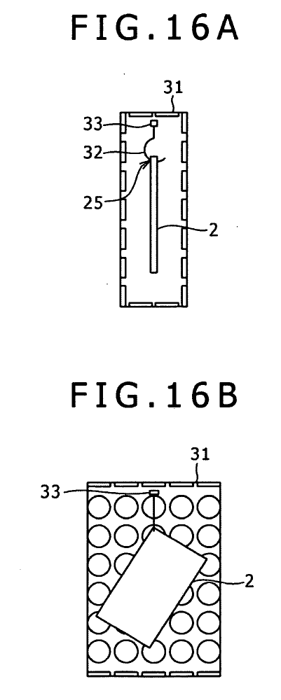

FIGS. 16A and 16B diagrammatically show an example of the air flow and temperature in the heating oven 31. A plurality of rectangles shown in the heating oven 31 in each of FIGS. 16A and 16B diagrammatically show the air flow in the heating oven 31. The larger the rectangle, the larger the air flow. Circles shown in FIG. 16B diagrammatically show the temperature in the heating oven 31. The larger the circle, the higher the temperature.

As shown in FIG. 16A, in the heating oven 31, both the opposite principal surfaces of the optical element covering member 2 are uniformly exposed to hot air, and, as shown in FIG. 16B, the temperature in the heating oven 31 is kept almost uniform.

When the heat treatment is conducted in a state such that the principal surface of the optical element covering member 2 is vertical, both the opposite principal surfaces of the optical element covering member 2 can be uniformly heated. Accordingly, the bonding portion 22a formed on the edge face of the optical element covering member 2 can be prevented from shifting to the principal surface, or light leakage, shrinkage irregularity, or the like caused due to local heating can be suppressed.

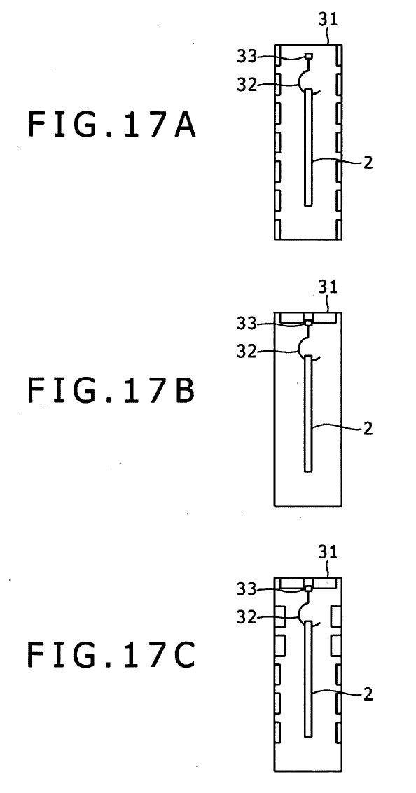

FIGS. 17A to 17C diagrammatically show other examples of the air flow in the heating oven 31. Like the rectangles in FIG. 16, a plurality of rectangles shown in the heating oven 31 in FIG. 17 diagrammatically show the air flow in the heating oven 31.

In the example shown in FIG. 17A, the optical element covering member 2 is exposed to hot air only from the side portion of the heating oven 31. In FIG. 17, the side on which the hanger 32 is provided is referred to as “upper portion”, the side opposite to the upper portion on which the hanger 32 is not provided is referred to as “lower portion”, and the side between the upper portion and the lower portion is referred to as “side portion”.

In the example shown in FIG. 17B, the optical element covering member 2 is exposed to hot air only from the upper portion of the heating oven 31. In the example shown in FIG. 17C, the air flow to the optical element covering member 2 from the upper portion of the heating oven 31 is increased.

The optical element covering member 2 is hanged by the hanger 32 as shown in FIG. 15, and therefore, in the lower portion of the support medium 22, a gap is likely to be caused between the support medium 22 and the optical element stacked member 21 before subjected to heat treatment. On the other hand, in the upper portion of the covering member 22, wrinkles in the covering member 22 before subjected to the heat treatment or the like and the position displacement of the optical element stacked member 21 are easily suppressed due to their own weights. As a result, when the air flow in the upper portion of the heating oven 31 is increased as shown in FIGS. 17B and 17C, the upper portion of the covering member 22 is first permitted to heat-shrink, making it possible to prevent wrinkles, position displacement of the optical element stacked member 21, and the like caused during shrinking.

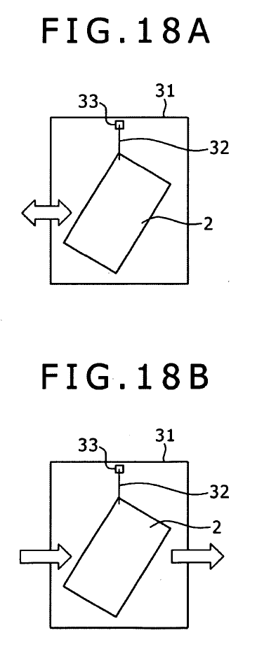

In the heat treatment, a batch-wise system shown in FIG. 18A or an in-line system shown in FIG. 18B may be employed. In an example of a batch-wise system shown in FIG. 18A, the optical element covering member 2 hanged by the hanger 32 is placed in the heating oven 31 and subjected to the heat treatment and then removed from the heating oven 31, and this cycle of treatment is performed repeatedly.

In an example of an in-line system shown in FIG. 18B, an inlet and an outlet for the optical element covering member 2 are formed in the heating oven 31, and a transport path 33 is formed on the line passing through the inlet and outlet. The optical element covering member 2 passing through the heating oven 31 from the inlet to the outlet is subjected to the heat treatment within the heating oven 31.

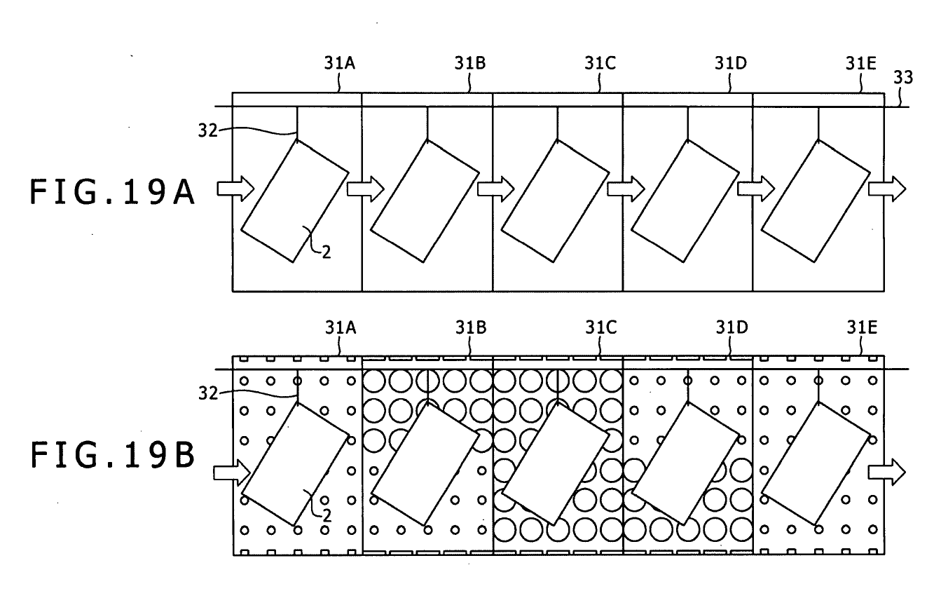

FIGS. 19A and 19B show another example of an in-line system. In FIG. 19, the heating oven 31 is divided into a plurality of zones, and the zones are arranged in an in-line form. In the example shown in FIG. 19, five zones, i.e., a heating oven 31A, a heating oven 31B, a heating oven 31C, a heating oven 31D, and a heating oven 31E are arranged along the transport path 33. An inlet is positioned on the side of the heating oven 31A, and an outlet is positioned on the side of the heating oven 31E.

The optical element covering member 2 is subjected to the heat treatment in the heating ovens 31A to 31E having respective temperatures. FIG. 19B diagrammatically shows the temperatures in the heating ovens 31A to 31E. Circles shown in FIG. 19B diagrammatically show the temperatures in the heating ovens 31A to 31E. The larger the circle, the higher the temperature.

As shown in FIG. 19B, the heating temperatures in the individual heating ovens 31 different from one another can be used. For example, the optical element covering member 2 is preheated in the heating oven 31A. In the heating oven 31B, the temperature of the upper portion is higher than the temperature of the lower portion. The temperature in the heating oven 31C is kept high and almost uniform. In the heating oven 31D, the temperature of the lower portion is higher than the temperature of the upper portion. In the heating oven 31E, the whole temperature is reduced to gradually lower the temperature of the optical element covering member 2.

The optical element covering member 2 is transported along the transport path 33 in the direction indicated by arrows shown in FIG. 19 and subjected to the heat treatment.

FIG. 20 shows another example of a heating apparatus. A heating apparatus 31 shown in FIG. 20 has a plurality of hangers 32 in a transport path 33. The hangers 32 are individually engaged with hole portions 25 respectively formed in an optical element covering member 2A, an optical element covering member 2B, an optical element covering member 2C, an optical element covering member 2D, and an optical element covering member 2E. A plurality of optical element covering members 2 are transported in the direction indicated by an arrow shown in FIG. 20. The heating apparatus 31 has such a capacity that it can contain a plurality of optical element covering members, and achieves the heat treatment for a plurality of optical element covering members 2 at the same time.

The heat treatment is conducted as described above, thus obtaining a covering member 22. Then, if desired, the principal surface of the covering member 22 may be subjected to, e.g., treatment for removal of air by means of a roller.

### SECOND EXAMPLE

In the second example, in the step for heat treatment in which heat is applied to the covering member 22 to cause the covering member to heat-shrink, the edge face of the optical element covering member 2 is put down. The procedures in the method other than the step for heat treatment are the same as those in the first example, and therefore the descriptions of them are omitted. The second example of heat treatment is described below.

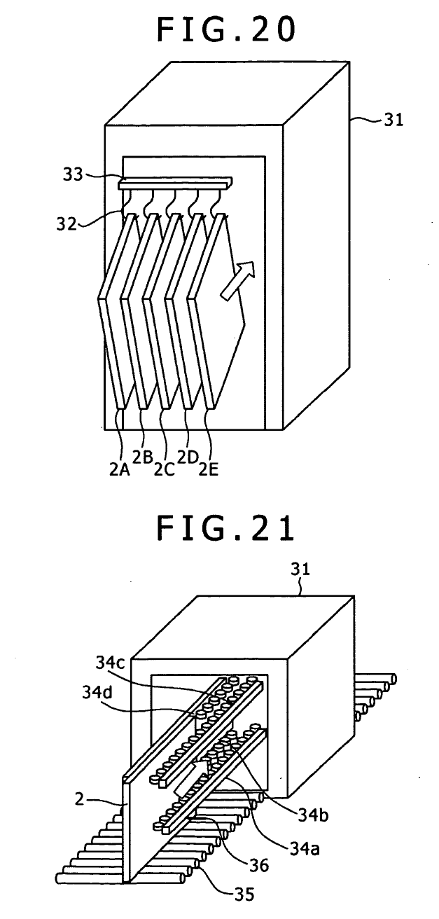

FIG. 21 shows an example of the heating apparatus used in the second example. This heating apparatus includes a pair of support mediums 34a, 34b and a pair of support mediums 34c, 34d (hereinafter, referred to simply as “support medium 34” unless otherwise specified) for supporting the optical element covering member 2 in a state such that the principal surface of the optical element covering member 2 is substantially vertical, a transport path 35 for transporting the optical element covering member 2, and a heating oven 31 into which the optical element covering member 2 is fed by the transport path 35.

A pair of support mediums 34a and 34b are provided so that they oppose each other. The optical element covering member 2 is disposed between the support mediums 34a and 34b, and the principal surfaces of the optical element covering member 2 and the support mediums 34a and 34b are respectively in contact to hold the optical element covering member in a state such that the principal surface of the optical element covering member 2 is substantially vertical. The width of the support mediums 34a and 34b is appropriately selected depending on the width of the edge face of the optical element covering member 2.

On the surfaces of the support mediums 34a and 34b which are in contact with the principal surfaces of the optical element covering member 2, that is, on the surfaces of the support mediums 34a and 34b which oppose each other are formed, for example, a plurality of continuous and rotating rollers. With respect to the surface of the roller, for preventing rubbing (passing mark) caused due to the optical element covering member 2 passing between the support mediums 34a and 34b, or flaws and the like caused due to friction, it is preferred to use a super engineering plastic material, such as polyether ether ketone (PEEK) or polyphenylene sulfide (PPS), which is a heat resistant resin.

A pair of support mediums 34c and 34d have the same constructions as those of the support mediums 34a and 34b, and therefore the descriptions of them are omitted.

As another example of the construction in which the optical element covering member is supported in a state such that the principal surface of the optical element covering member 2 is vertical, there can be mentioned a construction (not shown) in which both the principal surfaces of the optical element covering member 2 are exposed to air in the opposite direction to support the optical element covering member in a state such that the principal surface of the optical element covering member 2 is vertical. In this case, the support medium 34 shown in FIG. 21 is not required, thus avoiding a disadvantage in that a passing mark or the like is caused in the package due to contact with the support medium 34.

The transport path 35 includes a conveyer which can transport the optical element covering member 2 placed on the conveyer. The edge face of the optical element covering member 2 is put down and placed on the transport path 35, and the optical element covering member is transported in a state such that the principal surface of the optical element covering member 2 is vertical. A groove portion (not shown) may be formed in the transport path 35 in the direction along the transport line, and the optical element covering member can be placed so that the edge face of the optical element covering member 2 is positioned in the groove portion. In this case, the principal surface of the optical element covering member 2 can be held more stably.

In the second example, as shown in FIG. 21, a fixing member 36 is engaged with the hole portion 25 in the optical element covering member 2. The fixing member 36 is composed of a needle, rod, or the like which can be fitted into the hole portion 25 in the optical element covering member 2. The optical element covering member 2 fixed by the fixing member 36 is transported in the direction indicated by an arrow shown in FIG. 21 and subjected to the heat treatment. By fixing the optical element covering member 2 by the fixing member, position displacement between the optical element and the support medium can be suppressed during the heat treatment.

The same heating temperature, air flow, and others as those in the first example can be used, and therefore the descriptions of them are omitted.

As described above, in a first embodiment, the hole portion 25 is formed in the outer edge portion of the optical element covering member 2, and the heat treatment is conducted in a state such that the fixing member is engaged with the hole portion, thus preventing position displacement between the optical element 24 and the support medium 23. Further in the principal surface of the optical element covering member 2, each of the incident surface and the transmission surface can be uniformly heated. Accordingly, the optical element covering member 2 can be prevented from suffering warpage, or light leakage, shrinkage irregurality, or the like caused due to local heating. Further, position displacement of the bonding portion of the covering member 22 can be suppressed.

The protrusion 7 formed in the backlight chassis 4 is fitted into the hole portion 25 formed in the outer edge portion of the optical element covering member 2 to fix the optical element covering member 2 to the backlight chassis 4, thus preventing the package from moving due to thermal expansion or the like. The optical element covering member 2 can be disposed at a specific position with respect to the light source 11, and therefore, for example, the light control film 24d can be effectively used. In addition, the optical element 24, e.g., even a thin light control film may be disposed immediately above the light source in the form integrated with the support medium 23 into one component using the covering member 22. Accordingly, it is possible to achieve a liquid crystal display device which is reduced in thickness, frame width, and weight.

Further, by using the optical element covering member 2 in the production of liquid crystal display device, not only can a plurality of optical elements 24 be prevented from being stacked in a wrong order, but also the number of steps for the production can be reduced.

### (2) Second Embodiment

FIG. 22 shows an example of the construction of a backlight according to a second embodiment. In the second embodiment, instead of the reflection-type polarizer 24c disposed immediately under the second region R2 of the covering member 22 in the first embodiment, a lens film 24b, such as a prism sheet, is disposed.

The lens film 24b is an optical element having a pattern formed in the surface of a transparent support medium. With respect to the optimum shape of the pattern formed in the surface, preferred is a shape of triangle. The light emitted from the light source 11 is reflected or refracted and condensed by the prism pattern formed in the film. With respect to the lens film 24b used in the second embodiment, there is no particular limitation, but, for example, BEF, manufactured and sold by Sumitomo 3M, may be used.

For suppressing glare of the lens film 24b, it is preferred that the second region 22b of the covering member 22 has appropriate dispersing power.

As shown in FIG. 22, for example, an optical element covering member 2 and a reflection-type polarizer 24c as an optical element are disposed in this order in the direction of from the lighting device 1 to the liquid crystal panel 3. The optical element covering member 2 includes a diffuser plate 23a, a diffuser film 24a, and the lens film 24b, which are integrated into one component and covered with the covering member 22.

### (3) Third Embodiment

In the third embodiment, the covering member 22 in the first embodiment has an optical element function imparted. The covering member 22 has an optical element functional layer formed in at least one of the first region R1 and the second region R2. The optical element functional layer is formed on, for example, at least one of the inner surface and outer surface of the covering member 22. The optical element functional layer improves the light emitted from the lighting device 1 in desired properties by subjecting the light to predetermined treatment. Examples of optical element functional layers include a diffuser functional layer having an ability to diffuse the incident light, a condenser functional layer having an ability to condense light, and a light source dividing functional layer having an ability to divide the light source in a line form or a dot form. Specifically, for example, the optical element functional layer has disposed thereon a structure, such as a cylindrical lens, a prism lens, or a fly eye lens. The optical element functional layer may have a structure, such as a cylindrical lens or a prism lens, to which wobble is added. With respect to the optical functional layer, there may be used, e.g., an ultraviolet light cutting functional layer (UV cutting functional layer) for cutting ultraviolet light or an infrared ray cutting functional layer (IR cutting functional layer) for cutting infrared ray.

Examples of methods for forming an optical functional layer for the covering member 22 include: a method in which a resin material is applied to the covering member 22 and dried to form a diffusing functional layer, a method in which, upon forming a film or sheet constituting the covering member 22, diffusing particles are added to or voids are formed in a resin material, followed by extrusion or co-extrusion, to form a film or sheet of a single layer or multilayer structure; a method in which a predetermined shape is formed by transfer molding in a resin material, such as an ultraviolet curing resin, to form a diffusing functional layer, a condenser functional layer, e.g., a lens, or a light source dividing functional layer having an arbitrary form; a method in which a shrinkable film having a predetermined shape for shrinkage factor preliminarily transferred thereto upon being formed, and having shrinkability by stretching is used; a method in which a shrinkable film having the above-mentioned functional layer transferred thereto by heat or pressure is used; and a method in which micropores are formed in a film mechanically or by thermal processing using a laser or the like.

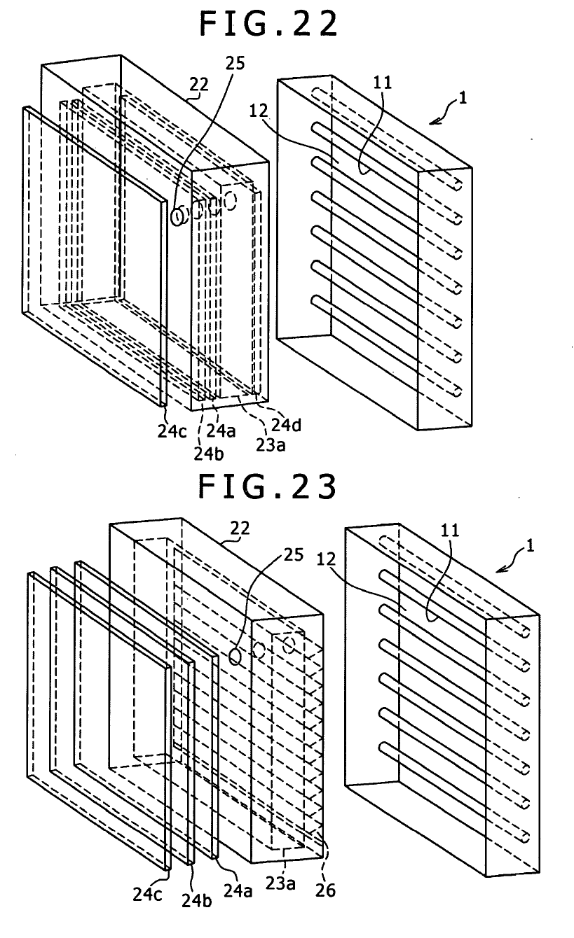

FIG. 23 shows an example of the construction of a backlight according to a third embodiment. As shown in FIG. 23, for example, a diffuser plate 23a, a diffuser film 24a, a lens film 24b, and a reflection-type polarizer 24c are disposed in this order in the direction of from the lighting device 1 to the liquid crystal panel 3. The diffuser plate 23a is covered with a covering member 22, and a structure 26 having an irregularity removing function or the like is formed on the inner surface of the covering member 22 on the incident side.

In the third embodiment, a structure and an optical functional layer are formed on at least one of the inner surface and outer surface of the covering member 22, and therefore the number of the optical elements covered with the covering member 22 can be reduced, thus achieving an optical element covering member 2 or liquid crystal display device further reduced in thickness.

### EXAMPLES

Hereinbelow, the embodiments will be described in more detail with reference to the following Examples, which should not be construed as limiting the scope of the embodiments.

Sample 1

Optical elements and a support medium shown below were first prepared. The optical elements and support medium are for television of 32-inch size, and each optical element has a size of 408 mm×708 mm and the support medium (diffuser plate) has a size of 410 mm×710 mm.

Reflection-type polarizer (DBEFD, manufactured and sold by 3M; thickness: 400 μm)

Lens sheet (Lens; hyperboloidal form shaped by PC melt extrusion; pitch: 200 μm; manufactured and sold by Sony Corporation; thickness: 500 μm)

Diffuser sheet (BS-912, manufactured and sold by KEIWA Inc.; 205 μm)

Diffuser plate (polycarbonate, manufactured and sold by Teijin Chemicals Ltd.; thickness: 1,500 μm)

Light control film (unevenness removing film; hyperboloidal form shaped by PC melt extrusion; pitch: 200 μm; thickness: 200 μm)

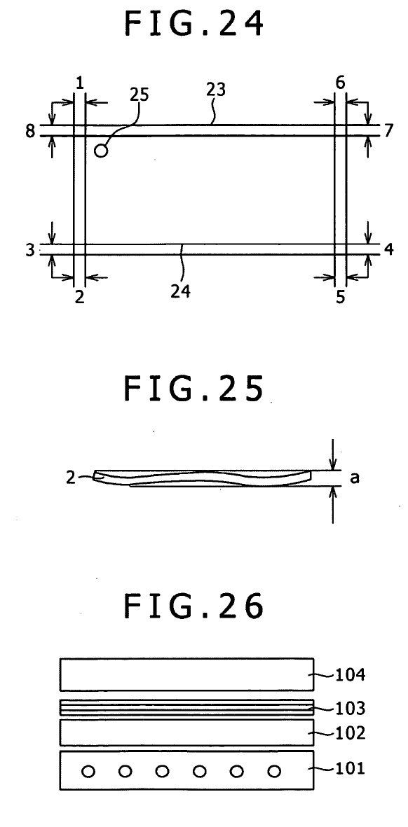

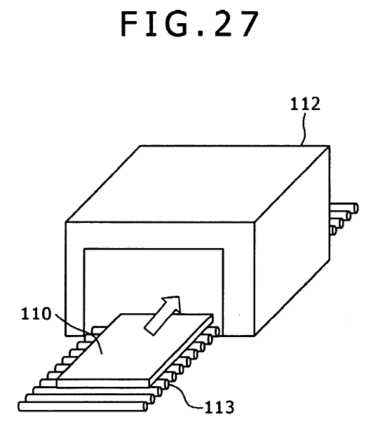

Then, a diffuser plate, a diffuser sheet, a lens sheet, and a reflection-type polarizer were disposed in this order on a light control film to obtain an optical element stacked member. In this instance, the optical element was disposed in a position relative to the diffuser plate as shown in FIG. 24. FIG. 24 shows arrangement of the diffuser plate and the optical element. In FIG. 24, a place 1 has a width of 1.1 mm indicated by arrows, a place 2 has a width of 1.1 mm indicated by arrows, a place 3 has a width of 1.4 mm indicated by arrows, a place 4 has a width of 1.4 mm indicated by arrows, a place 5 has a width of 0.8 mm indicated by arrows, a place 6 has a width of 0.8 mm indicated by arrows, a place 7 has a width of 1.2 mm indicated by arrows, and a place 8 has a width of 1.2 mm indicated by arrows.

Then, a raw sheet of a polyethylene film having heat shrinkability was prepared, and two rectangular films were cut from the raw sheet.

Then, the two films were put on each other so that an angle between the orientation axes of the films was 2 degrees, and the three sides other than one long side were heat-sealed to obtain a covering member in a bag form having a size of 410 mm×714 mm. The above-obtained optical element stacked member was inserted to the opened long side of the covering member. Then, the covering member was sealed up by heat-sealing the opened long side to obtain an optical element covering member. The heat sealing was conducted by heating the edge of the covering member at 220° C. for 2 seconds. Then, an opening was formed in a position corresponding to the corner portion of the covering member. A hole portion was formed by drilling in the corner portion through which the optical element stacked member was exposed.

Then, a hanger was fitted into the hole portion and the hanger was fixed to a ceiling of a heating oven, and the optical element covering member hanged by the hanger was subjected to the heat treatment. The heat treatment was conducted in an environment at a temperature of 105° C. to cause the covering member to shrink, so that the optical element stacked member and the covering member were in contact and the corner portion of the optical element stacked member was exposed through the opening formed in the corner portion of the support medium.

Thus a desired optical element covering member was obtained.

Samples 2 to 5

Optical element covering members were individually obtained in the same manner as in sample 1.

Samples 6 to 10

Optical element covering members were individually obtained in substantially the same manner as in sample 1 1 except that the heat treatment was conducted in a state such that the hanger was not fitted into the hole portion and one principal surface of the optical element covering member was put down and placed on the bottom.

Evaluation of the Position Displacement

With respect to each of the optical element covering members of samples 1 to 10, a width of each of the places 1 to 8 shown in FIG. 24 was measured by means of a slide gauge. From the values measured, an error was determined using an average and a standard deviation, and evaluated in accordance with the following criteria.

∘: Error is 0.25 or less.

Δ: Error is more than 0.25 to 0.50.

×: Error is more than 0.50.

Evaluation of Warpage

With respect to each of the optical element covering members of samples 1 to 10, one principal surface was put down and placed on a flat bottom, and a width a indicated by arrows shown in FIG. 25 was measured by means of a slide gauge. From the values measured, an error was determined using an average and a standard deviation, and evaluated in accordance with the following criteria.

∘: Error is 1.0 or less.

Δ: Error is more than 1.0 to 2.5.

×: Error is more than 2.5.

The results of the evaluation of position displacement of the samples 1 to 5 are shown in Table 1 below. The results of the evaluation of position displacement of the samples 6 to 10 are shown in Table 2 below.

TABLE 1

| | Design | | | | | | | | |
|---|---|---|---|---|---|---|---|---|---|
| | value | Sample 1 | Sample 2 | Sample 3 | Sample 4 | Sample 5 | Average | | |
| Place | (mm) | (mm) | (mm) | (mm) | (mm) | (mm) | (mm) | Error | Evaluation |
| 1 | 1.1 | 1.13 | 1.04 | 1.16 | 1.21 | 1.03 | 1.11 | 0.07 | ∘ |
| 2 | 1.1 | 0.81 | 1.12 | 0.90 | 1.15 | 1.05 | 1.01 | 0.13 | ∘ |
| 3 | 1.4 | 1.53 | 1.55 | 1.63 | 1.53 | 1.30 | 1.51 | 0.11 | ∘ |
| 4 | 1.4 | 1.17 | 1.33 | 1.00 | 1.02 | 1.44 | 1.19 | 0.17 | ∘ |
| 5 | 0.8 | 0.91 | 0.75 | 0.94 | 0.74 | 0.53 | 0.78 | 0.14 | ∘ |
| 6 | 0.8 | 0.76 | 0.93 | 0.68 | 0.77 | 0.92 | 0.81 | 0.10 | ∘ |
| 7 | 1.2 | 1.38 | 1.24 | 1.42 | 1.41 | 1.10 | 1.31 | 0.12 | ∘ |
| 8 | 1.2 | 0.90 | 1.15 | 0.99 | 1.09 | 1.17 | 1.06 | 0.10 | ∘ |

TABLE 2

| | Design | | | | | Sample | | | |
|---|---|---|---|---|---|---|---|---|---|
| | value | Sample 6 | Sample 7 | Sample 8 | Sample 9 | 10 | Average | | |
| Place | (mm) | (mm) | (mm) | (mm) | (mm) | (mm) | (mm) | Error | Evaluation |
| 1 | 1.1 | 1.34 | 0.75 | 1.20 | 0.31 | 1.54 | 1.03 | 0.44 | □ |
| 2 | 1.1 | 1.01 | 1.47 | 1.84 | 0.24 | 1.76 | 1.26 | 0.59 | x |
| 3 | 1.4 | 1.38 | 0.27 | 1.63 | 0.42 | 0.85 | 0.91 | 0.53 | x |
| 4 | 1.4 | 0.10 | 1.24 | 0.03 | 0.98 | 0.06 | 0.48 | 0.52 | x |
| 5 | 0.8 | 0.68 | 0.32 | 0.18 | 1.78 | 0.65 | 0.72 | 0.56 | x |
| 6 | 0.8 | 0.34 | 0.98 | 0.68 | 1.75 | 0.21 | 0.79 | 0.55 | x |
| 7 | 1.2 | 1.96 | 1.75 | 1.55 | 1.38 | 1.87 | 1.70 | 0.21 | ∘ |
| 8 | 1.2 | 0.90 | 1.15 | 0.24 | 1.67 | 1.54 | 1.10 | 0.51 | x |

The results of the evaluation of warpage of the samples 1 to 5 are shown in Table 3 below. The results of the evaluation of warpage of the samples 6 to 10 are shown in Table 4 below. The design value shown in the Tables 1 to 4 indicates a value before the heat treatment.

TABLE 3

| | Design | | | | | | | | |
|---|---|---|---|---|---|---|---|---|---|
| | value | Sample 1 | Sample 2 | Sample 3 | Sample 4 | Sample 5 | Average | | |
| Place | (mm) | (mm) | (mm) | (mm) | (mm) | (mm) | (mm) | Error | Evaluation |
| a | 2 | 3 | 4 | 3 | 2 | 3 | 3.0 | 0.6 | ∘ |

TABLE 4

| | Design | | | | | Sample | | | |
|---|---|---|---|---|---|---|---|---|---|
| | value | Sample 6 | Sample 7 | Sample 8 | Sample 9 | 10 | Average | | |
| Place | (mm) | (mm) | (mm) | (mm) | (mm) | (mm) | (mm) | Error | Evaluation |
| a | 2 | 5 | 8 | 12 | 6 | 10 | 8.2 | 2.6 | x |

As seen from Table 1, with respect to the samples 1 to 5, the error between the samples is small, and excellent results of evaluation are obtained at all the places 1 to 8. In contrast, as seen from Table 2, with respect to the samples 6 to 10, the error between the samples is large, and the difference between the design value and the average is large. From the above results, it is apparent that, by conducting the heat treatment in a state such that the optical element stacked member is fixed, the position displacement between the support medium and the optical element can be suppressed.

As seen from Table 3, with respect to the samples 1 to 5, the error between the samples is small, and the value of warpage is 4 mm at the most. In contrast, as seen from Table 4, with respect to the samples 6 to 10, the error between the samples is large, and the average of warpage is as large as 8.2 mm. From the above results, it is apparent that, by heating the optical element covering member in a state such that the principal surface of the optical element stacked member is vertical, warpage of the optical element covering member can be suppressed.

Hereinabove, embodiments are described in detail but are not limited to the above examples, and can be changed or modified.

For example, the values or numbers described in the above embodiments are merely examples, and values or numbers different from them can be used if desired.

The constructions in the above embodiments can be used in combination as long as the effect of the present embodiments can be obtained.

In the above embodiments, the heat treatment for the optical element covering member hanged by a hanger can be conducted while rotating the optical element covering member. In this case, the heating temperature for the optical element covering member can be uniform.

In the above embodiments, the optical elements or the optical element and the support medium can be bonded at a portion of them as long as the optical function is not sacrificed. From the viewpoint of suppressing the deterioration of display function, it is preferred that they are bonded at their ends.

In the above embodiments, an example in which the support medium in the form of a film or sheet is used is described, but, with respect to the covering member, a casing having stiffness or the like may be used.

Although, in the above embodiments, the hole portion 25 is provided in an outer edge of the optical element covering member 2, a recess may be provided instead of the hole portion 25. This recess is, for example, provided in either one or both of incident surface and emergent surface. Alternatively, both of the hole portion 25 and the recess may be provided in outer edge of the optical element covering member 2. The recess may be formed by the application of pressure to the surface of the optical element covering member 2, for example. The forming method of the recess is not limited to the method by the pressure application as long as the recess can be formed in the surface of the optical element covering member 2.

By providing such a recess and performing heat treatment in the production step of the optical element covering member while engaging a fixed member to the recess, the alignment deviations of the optical element 24, the support medium 23, and the like can be reduced.

As described above, according to embodiments, the optical element can be improved in stiffness while preventing an increase of the thickness of a liquid crystal display device and preventing deterioration of the display properties of a liquid crystal display device. Further, deterioration of the optical properties due to position displacement between the optical element and the support medium can be suppressed.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical element covering member comprising:
an optical element stacked member including at least one optical element and a support medium for supporting the at least one optical element; and
a covering member for covering the optical element stacked member,
wherein the optical element stacked member covered with the covering member has at least one hole portion formed in an outer edge portion thereof.

2. The optical element covering member according to claim 1, wherein the support medium is rectangular in shape, and the hole portion is formed in a corner portion of the support medium.

3. A backlight comprising:
a light source for emitting light;
a housing portion for containing the light source; and
an optical element covering member provided in the housing portion,
wherein the optical element covering member includes:
an optical element stacked member which includes at least one optical element and a support medium for supporting the at least one optical element; and
wherein the optical element stacked member covered with the support medium has at least one hole portion formed in an outer edge portion thereof,
wherein the housing portion has at least one protrusion formed therein,
wherein the protrusion formed in the housing portion is fitted into the hole portion formed in the optical element covering member.

4. The backlight according to claim 3, wherein the support medium is rectangular in shape, and the hole portion is formed in a corner portion of the support medium.

5. A liquid crystal display device comprising:
a backlight which includes a light source for emitting light, a housing portion for containing the light source therein, and an optical element covering member provided in the housing portion; and
a liquid crystal panel for displaying an image,
wherein the optical element covering member includes:
an optical element stacked member which includes at least one optical element and a support medium for supporting the at least one optical element; and
wherein the optical element stacked member covered with the support medium has at least one hole portion formed in an outer edge portion thereof,
wherein the housing portion has at least one protrusion formed therein,
wherein the protrusion formed in the housing portion is fitted into the hole portion formed in the optical element covering member.

6. The liquid crystal display device according to claim 5, wherein the support medium is rectangular in shape, and the hole portion is formed in a corner portion of the support medium.

7. A method for producing an optical element covering member, the method comprising the steps of:
covering at least one optical element and a support medium for supporting at least one optical element with a covering member to prepare an optical element covering member; and
subjecting the optical element covering member to a heat treatment so as to cause the support medium to shrink,
wherein the heat treatment is conducted while engaging a fixing member with a hole portion formed in an outer edge portion of the optical element covering member.

8. The method according to claim 7, wherein the optical element covering member has a principal surface including an incident surface opposing the light source and an transmission surface opposite to the incident surface,
wherein the heat treatment is conducted so that the temperature of the incident surface and the temperature of the transmission surface are substantially the same.

9. The method according to claim 7, wherein the optical element covering member has a principal surface including an incident surface opposing the light source and an transmission surface opposite to the incident surface,
wherein the heat treatment is conducted while maintaining the incident surface and the transmission surface in an open state.

10. The method according to claim 7, wherein the optical element covering member has a principal surface including an incident surface opposing the light source and an transmission surface opposite to the incident surface,
wherein the heat treatment is conducted while maintaining both the incident surface and transmission surface in a vertical state.

11. The method according to claim 7, wherein the heat treatment is conducted while hanging the optical element covering member by the fixing member.

12. The method according to claim 11, wherein an upper portion of the optical element covering member hanged by the fixing member is first subjected to the heat treatment.
